(19) United States
(12) Patent Application Publication
(10) Pub. No.: US 2004/0002872 A1
(43) Pub. Date: Jan. 1, 2004

(54) PDA-based prescription messaging method and object-oriented system

(76) Inventor: Donald Joe Wright, Beech Grove, IN (US)

Correspondence Address: BAKER & DANIELS, 300 NORTH MERIDIAN STREET, SUITE 2700, INDIANAPOLIS, IN, 46204-1782, US

(21) Appl. No.: 10/185,231

(22) Filed: Jun. 28, 2002

(51) Int. Cl. G06F 17/60

(52) U.S. Cl. 705/2

(57) ABSTRACT

The present invention involves a system and method which allows a sponsoring organization access to a physician's prescription process. The system electronically processes prescriptions via a personal digital assistant (PDA). First, the physician is provided with a PDA for generating prescription. The PDA transmits the prescription data over a network. A sponsor finances the PDA use and has the ability to direct messages to the physician on the PDA.

### BACKGROUND OF THE INVENTION

1. Field of the Invention

The invention relates to prescribing medication. More specifically, the field of the invention is that of electronic medication prescription systems.

2. Description of the Related Art

Adverse drug events (“ADEs”) are medical situations where an error in prescribed and administered medication results in a negative physical reaction by the patient. The consequences to patients who suffer from ADEs can range from minor allergic reactions to severe illnesses to death. ADEs have also been known to cause permanent disability.

Medication errors can occur at any time during the patient treatment process from the physician's initial prescription order, to transcription, to dispensing, and finally to the administration of the medications. An increasing number of complex drugs have been developed and made available to physicians to prescribe to their patients. The amount of information about new drugs and their potential interactions has made it quite difficult for physicians to stay completely informed and up-to-date. Accordingly, there is a heightened awareness in the health care industry of adverse drug events caused by prescriptions being filled incorrectly due to illegible handwriting, drug-to-drug interactions, allergies, improper dosages, formulary mistakes and other prescription mishaps. Information about new drugs that become available must be transmitted in such a way that a physician can be made aware of and remain responsive to the evolving landscape of the medical industry as it relates to drugs. For this reason, a method and system of safely and efficiently transmitting medical information is needed.

Reported ADEs have resulted in thousands of complications and deaths each year, and these events can cost hospitals millions of dollars. Patients who have suffered ADEs are hospitalized an average of one to two weeks longer than other patients at an additional hospital cost of between sixteen and twenty-four thousand dollars ($16,000-$24,000).

Avoiding adverse drug events is the responsibility of the physician, the prescribing technicians and the patients. For physicians and prescribing technicians, it is the function of memory, level of experience and training. Patients must also be responsible for remembering their active medicine lists to assist the physician in avoiding adverse drug events.

Estimates reveal that fewer than five-percent (5%) of medical practices and facilities use computerized systems in prescribing medications. By utilizing computerized prescription and monitoring systems to reduce the element of human errors during the prescription process, it has been estimated that about eighty-four (84%) of the adverse drug events can be prevented. When medication and prescription errors are made in hospitals, the hospitals sometimes voluntarily cover the costs of these mistakes. At other times, however, the hospitals pass the costs of these mistakes on to patients and insurance companies. By reducing the number of ADEs, hospitals could realize annual direct cost savings of as much as one-half million dollars ($500,000), and these are costs incurred by the hospitals and not passed on to insurance companies. The reduction of ADEs could also limit the costs passed on to insurance companies. ADEs may cost hospitals up to five-million six-hundred thousand dollars per year ($5,600,000) depending on the size of the hospital. As can be seen, ADEs cause both patients and hospitals to suffer. Patients suffer physically, emotionally and financially, and hospitals suffer financially. Improvement is needed to the medical and business problem of adverse drug events.

While pharmacies and drug manufacturers are typically compensated for the respective roles they fulfill in the prescription process, physicians are not directly compensated for the value they add to the process. In prescribing medication, the physician not only determines patient treatments, but she also creates a prescription transaction that facilitates and enhances business processes that benefit other interested parties—pharmacies, drug distributors, drug manufacturers, insurance companies, third party administrators, malpractice insurance providers and other parties. To the physician, however, there is little reward for the prescription process. While automated prescription processes are known, physicians have been slow to be adopt them because of the physicians' disinclination to change to new and unfamiliar systems.

### SUMMARY OF THE INVENTION

The present invention is a handheld prescription messaging method and system for providing a physician with a sponsor to finance the physician's use of a handheld device to electronically prescribe medications and facilitate electronic messaging between the physician and the physician's sponsor.

For purposes of this invention, the use of the term “sponsor” includes any entity that will pay a fee to sponsor a physician, e.g., a pharmacy or pharmacy chain, drug distributor, drug manufacturer, medical insurance company, third party administrator or malpractice insurance provider. The use of the terms “personal digital assistant” or “PDA” includes any handheld, mobile device that combines computing, telephone, facsimile, e-mail and networking features.

In the present invention, a method and system provides for compensating physicians for the role they play in the prescription process. By characterizing physicians as value-added components in the complete process of the prescription transaction cycle, the present invention enables a revenue stream to be provided to the physician that compensates her for directly benefiting the recipients of prescriptions that were created using the present invention.

New technology is needed in the health care industry to enable physicians, nurse practitioners and other health care professionals with the authority to write prescriptions to increase safety in the prescribing process. Analyses of physicians have determined that most physicians perceive themselves as scientists. As such, physicians tend to be tentative to adopt new information technology into their practice unless it is simple to implement and they see immediate benefits. This tentativeness to adopt new technology is magnified by a couple of factors. Physicians perceive that the use of new technology in their practices may adversely affect their relationships with their patients. For example, a physician may perceive the use of a handheld device to enter patient information while they interview, examine and treat a patient as impersonal. Also, physicians perceive that it will take more time to create an electronic prescription and electronically check the prescription for contradictions than it would take to do the same tasks manually. However, it takes no more time to create and check a prescription on a PDA than it takes to do so by hand. These factors add to a physician's tentativeness to seek new technology in treating her patients, and this tentativeness creates a problem because physicians are the ultimate decision-makers within their practice. Therefore, since new technology is needed in the health care industry to increase safety in the prescribing process, and because the decision to implement such technology most often falls into the hands of the physician, the physician needs an incentive to implement the technology into her practice. In implementing technology to increase safety and efficiency in the prescribing process, physicians are adding value to the prescription business process.

In the present invention, a method and system provides a physician with a sponsor. The sponsor pays for the physician's use of a PDA to generate electronic prescriptions. The sponsor may benefit from the physician's use of the PDA because by using the PDA, the physician gains an increased awareness of the sponsor's products and/or services. The sponsor's products and/or services may receive preferential presence either in front of the physician while the physician uses the PDA or by patients to whom the physician prescribes medication. In one form of the present invention, this preferential presence occurs in the form of sponsor logos being displayed on the physician's PDA screen. In another form of the present invention, this preferential presence occurs in the form of sponsor advertisements being printed on the prescriptions created by the physician on the PDA. In still another form of the present invention, this preferential presence occurs in the form of sponsor products being advantageously positioned within a drug listing displayed on the PDA screen.

In the present invention, a method and system further provides for electronically prescribing medications via a PDA. The present invention allows a physician to generate electronic prescriptions using her PDA. After generating the electronic prescription, the physician may save the electronic prescriptions into the PDA and transmit the electronic prescription over a network to a prescription-filling source.

In the present invention, a method and system preserves patient confidentiality when transmitting the electronic prescription to the prescription-filling source by providing authentication capability. Each prescription created using the method and system of the present invention is assigned a unique prescription identification number. The patient receives a printed receipt which includes the patient's name and unique prescription identification number. An electronic XML-based transaction containing the unique prescription identification number and non-confidential patient information, e.g., demographic data, is sent via the network from the physician's host computer to a secure, web-based central database. When the patient presents the prescription receipt to the prescription filling source, the person responsible for filling the prescription will access the secure central database via a web-browser and authorization code, enter the unique prescription identification number and complete the authentication process. In this way, confidential patient information will never be transmitted outside of the physician's host computer system.

In the present invention, a method and system also provides a notification to the physician via her PDA warning her that the prescription she entered may cause her patient to suffer from a potential adverse drug event. In one form of the present invention, the notification includes information regarding the patient's active prescriptions. In another form of the present invention, the notification includes information regarding the patient's allergies. In still another form of the present invention, the notification includes information regarding FDA approved drugs.

In the present invention, a method and system allows a physician and her sponsor to privately exchange electronic messages, the physician being able to send messages directly from and receive messages directly to her PDA. In one form of the present invention, the sponsor may send general messages to the physician. In another form of the present invention, the sponsor may send the physician messages regarding a particular drug class. In still another form of the present invention, the sponsor may send the physician messages regarding a particular drug category. In yet another form of the present invention, the sponsor may send the physician messages regarding a particular drug. In another form of the present invention, the sponsor may send the physician's patient messages regarding the filling of the patient's prescription.

Another aspect of the invention relates to a machine-readable program storage device for storing encoded instructions for a method of electronically prescribing medication and facilitating electronic messaging between a physician and her sponsor according to the foregoing method.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagram of the operation of the system of present invention.

FIG. 2 is a schematic diagram of the operation of the present invention relating to maintaining of patient confidentiality.

FIG. 3 is a schematic diagram of the operation of the present invention relating to the private messaging conduit between a physician's PDA and the physician's sponsor.

FIG. 4 is a schematic diagram of the operation of the present invention relating to the private messaging conduit between a physician's wireless PDA and the physician's sponsor.

FIG. 5 is a relationship diagram of the present invention relating to the benefits created by using the method of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and system for operating a computer in processing electrical or other (e.g., mechanical, chemical) physical signals to generate other desired physical signals.

The present invention also relates to a system for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives-a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network” or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The terms “desktop”, “personal desktop facility”, and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API”, to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines one or more of the computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (“CDPD”) used on the Advance Mobile Phone Service (“AMPS”).

The terms “wireless application protocol” or “WAP” mean a universal specification to facilitate the delivery and presentation of web-based data on handheld and mobile devices with small user interfaces.

In an exemplary design, the present invention involves a handheld prescription messaging method and system for providing a physician with a sponsor to finance the physician's use of a handheld device to electronically prescribe medications and facilitate electronic messaging between the physician and the physician's sponsor.

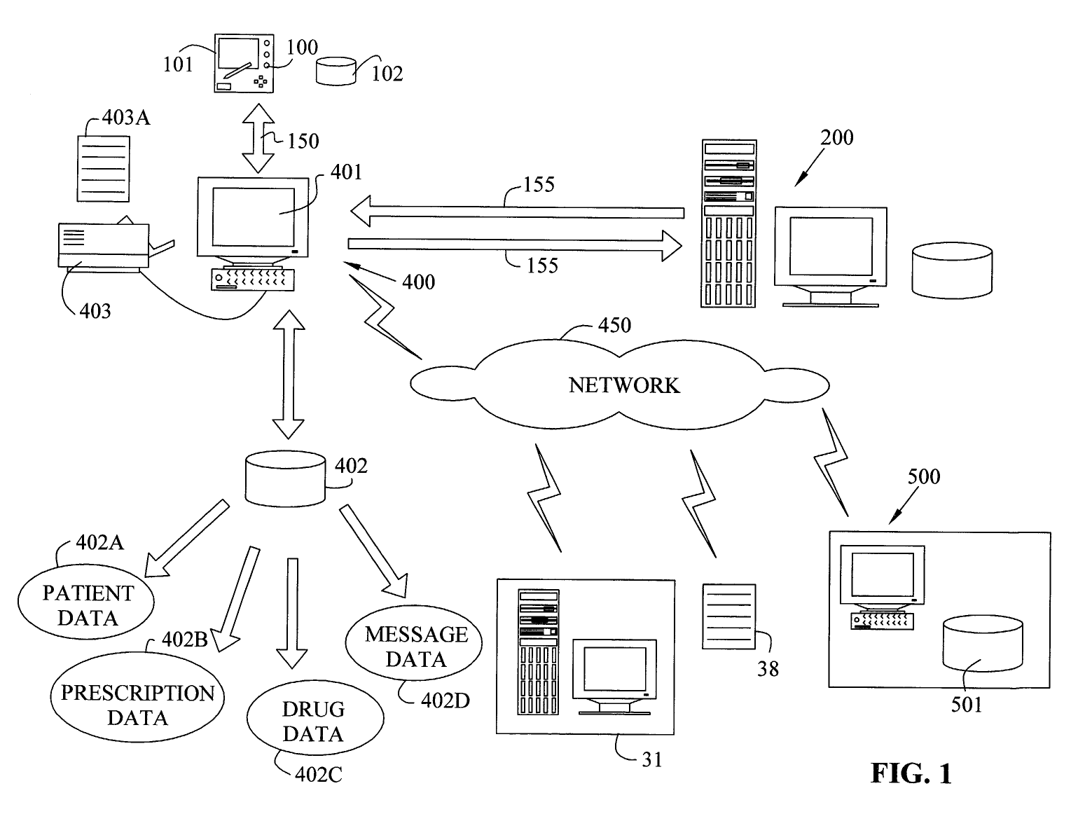

The method and system of the present invention is shown in FIG. 1. Host computer 400 includes host computer interface 401, host computer database 402 and host computer printer 403. For purposes of this invention, a “host computer” is a computer which allows physicians and medical staff to benefit from all of the functionality of the physician's PDA. The host computer communicates with one or more practice management systems (“PMS”) via a network to obtain information, including but not limited to, provider information, patient demographics, insurance information, and appointments. The host computer also may do the following: 1) determine a list of patients to be synchronized with a physician's PDA; 2) set application preferences pertaining to the physician's practice; 3) serve as the host database for synchronization with the PDA; 4) serve as the web-based host for drug file updates; 5) serve as the host for transmitting XML-based prescription transactions to the filling agent(s); 6) create reports pertaining to patients and their active and expired medications; 7) maintain patient demographic data specific to patient prescriptions processing when the patient demographic data is not available in the practice management system; and 8) maintain all prescription history.

Host computer database 402 stores patient data 402a, prescription data 402b, drug data 402c and message data 402d. Patient data 402a may include, but is not limited to, the following data: 1) a patient's schedule data; 2) a patient's name; 3) a patient's age; 4) a patient's sex; 5) a patient's weight; 6) a patient's height; 7) a patient's allergies; 8) a patient's medical history; and other patient data. Prescription data 402b may include, but is not limited to, a patient's active prescriptions and the patient's most recent prescription. Drug data 402c includes, but is not limited to, a FDA approved drug file, patient active drug data, patient allergy data and harmful drug interaction data. Patient active drug data includes information relating to any active drugs which the patient takes. Patient allergy data includes information related to any allergies from which a patient suffers. Harmful drug interaction data includes information relating to any dangerous interactions between drugs actively prescribed by the physician.

Host computer database 402 is populated in a couple of ways. Practice management system 200 may transmit patient data 402a over interface 155 to host computer 400. A user of host computer 400 may also input patient data 402a into host computer database 402 as the data is gathered by the physician and/or her staff.

In accordance with the method and system of the present invention, a physician is provided with PDA 100. PDA 100 may be one of any of the commercial handheld devices on the market, including, but not limited to any of the following: Palm's handheld devices (PALM is a registered trademark of Palm Inc. of Santa Clara, Calif.), Sony's handheld devices (SONY is a registered trademark of Sony Corporation of Tokyo, Japan), Hewlett Packard's handheld devices (HEWLETT PACKARD is a registered trademark of Hewlett Packard Company of Palto Alto, Calif.), Toshiba's handheld devices (TOSHIBA is a registered trademark of Toshiba Corp. of Tokyo, Japan), Handspring's handheld devices (HANDSPRING is a registered trademark of Handspring Inc. of Palto Alto, Calif.) or Microsoft's Pocket PC. In an exemplary embodiment of the present invention, PDA 100 is a Palm handheld device.

PDA 100 includes PDA interface 101 and PDA data storage 102. Patient data 402a, prescription data 402b, drug data 402c and message data 402d are stored in PDA data storage 102. Before seeing her patients, the physician synchronizes PDA 100 with host computer 400 via transmission channel 150. In one form of the present invention, transmission channel 150 may be a Universal Serial Bus (“USB”) used in conjunction with a docking cradle. In another form of the present invention, transmission channel 150 may be a serial connection used in conjunction with a docking cradle. In still another form of the present invention, transmission channel 150 may be a wireless transmission medium.

In synchronizing PDA 100 with host computer 400, patient data 402a, prescription data 402b, drug data 402c and message data 402d, stored in PDA data storage 102, is updated to reflect the corresponding data in host computer database 402. For example, before synchronization, patient data 402a in host computer database 402 includes the physician's daily schedule and pertinent information regarding each patient who is on the physician's daily schedule (i.e., if the patient is a returning patient whose personal informaton has been previously inputted into host computer database 402). Also before synchronizaton, prescription data 402b in host computer database includes active prescription information for each of the patients who is on the physician's daily schedule and whose information has been previoulsy inputted into host computer database 402. Likewise, before synchronization, drug data 402c in host computer database 402 includes allergy data and active drug data for each of the patients who is on the physician's daily schedule and whose relevant information has been previoulsy inputted into host computer database 402. Drug data 402c in host computer database 402 also includes an FDA approved drug file and drug interaction data. Message data 402d includes messages that are stored in host computer database 402 before synchronization.

PDA data storage 102 may include data corresponding to patient data 402a stored in host computer database 402 regarding returning patients, but PDA data storage 102 may or may not include the physician's daily patient schedule, depending on whether PDA 100 has been recently synchronized with host computer 400. Likewise, if the FDA-approved drug file and drug interaction data have been updated in host computer database 402 since PDA 100 was last synchronized with host computer 400, PDA data storage 102 may not include this data. PDA storage 102 may also not include any messages that have been stored in computer database 402 since the last time PDA 100 was synchronized. During the periodic synchronization process between PDA 100 and host computer 400, PDA data storage 102 is updated to include the daily patient schedule, the updated FDA-approved drug file, the updated drug interaction data and any updated message data. Through a wireless connection to host computer 400, if available, PDA 100 may be updated more regularly without requiring the physician to initiate a synchronization.

Because PDAs are mobile devices, the physician may carry PDA 100 with her as she visits her patients. Upon interviewing a patient, the physician may use PDA interface 101 to enter patient data 402a into PDA 100. After diagnosing her patient, the physician may then enter prescription data 402b into PDA 100. Because prescription data 402b and drug data 402c are stored in PDA data storage 102, the physician may be alerted to potential ADEs via PDA 100 before prescribing a medication to her patient. In one form of the present invention, the physician is notified via PDA 100 when she prescribes a medication to her patient to which her patient is allergic. For example, unbeknownst to the physician, Patient A is allergic to Drug A. Using her PDA as described above, the physician may prescribe Drug A to Patient A. Because PDA data storage 102 maintains Patient A's allergy data, the method and system of the present invention provides a notification to the physician warning her of this possible ADE. The physician is alerted to this problem on PDA interface 101. PDA 100 may have software which identifies other similar drugs which may be prescribed as alternatives to Drug A. Accordingly, the physician may prescribe Drug B to Patient A in lieu of Drug A.

In another form of the present invention, the physician is notified via PDA 100 when she prescribes a medication to her patient which harmfully interacts with another of the patient's active prescriptions. For example, unbeknownst to the physician, Patient A is currently taking Drug A. Using PDA 100 as described above, the physician may prescribe Drug B, which fatally interacts with Drug A, to Patient A. Because PDA data storage 102 maintains both drug interaction data and Patient A's active prescription data, the method and system of the present invention provides a notification to the physician warning her of this potential harmful drug interaction. Again, the physician is alerted to this problem on PDA interface 101. In this way, the physician may prescribe Drug C, which does not interact with Drug A, to Patient A.

In still another form of the present invention, the physician is notified via her PDA if she prescribes a medication to her patient for a condition which is not approved by the FDA. For example, unbeknownst to the physician, the FDA has disapproved the use of Drug A for treating particular health conditions. Using PDA 100, the physician may prescribe Drug A to Patient A for Patient A's condition. Because PDA data storage 102 maintains an FDA approved-drug file, the method and system of the present invention provides a notification to the physician warning her that Drug A is no longer an FDA-approved drug for Patient A's condition. Again, the physician is alerted to this problem on PDA interface 101. The physician may then prescribe another drug to Patient A which meets FDA approval for Patient A's condition.

In yet another form of the present invention, the physician is notified via her PDA if she prescribes a medication to her patient which should not have been prescribed due to her patient's medical condition. For example, the physician's patient, Patient A, may have a heart condition and diabetes. Unbeknownst to the physician, Drug A may be dangerous when prescribed to a patient with diabetes. Using PDA 100, the physician may prescribe Drug B, which contains inactive Drug A, to Patient A for Patient A's heart condition. Because PDA storage 102 maintains a list of active drugs, the present invention provides a notification to the physician warning her that Drug A becomes active when it encounters high glucose levels in the body. The physician is alerted to this problem on PDA interface 101. Knowing that Patient A has diabetes and understanding that Patient A is likely to have a high glucose level, the physician may prescribe Drug C, which does not contain Drug A, to Patient A.

In another form of the present invention, the physician is notified via her PDA if she prescribes a medication to her patient in an improper dosage when certain patient demographics, e.g., age, sex, weight, etc., are inconsistent with the dosage or the particular medication. For example, the physician's patient, Patient A, may weigh fifty-four (54) kilograms. Unbeknownst to the physician, Drug A may be dangerous when prescribed to persons weighing less than sixty-eight (68) kilograms. Using PDA 100, the physician may prescribe Drug A to Patient A for Patient A's condition. Because PDA storage 102 maintains drug data 102c, the present invention provides a notification to the physician warning her that Drug A is dangerous when prescribed to persons weighing less than sixty-eight (68) kilograms. The physician is alerted to this problem on PDA interface 101. The physician may then prescribe Drug B, which is better suited to Patient A's weight, to Patient A.

After the physician enters prescription data 402b into PDA 100, using PDA interface 101, she may save prescription data 402b in PDA data storage 102. After saving prescription data 402b in PDA data storage 102, the physician may again synchronize PDA 100 with host computer 400 so that any updated patient data 402a, prescription data 402b, drug data 402c and message data 402d is reflected in host computer database 402.

In one form of the present invention, the physician may electronically transmit prescription data 402b to filling agent 31. PDA 100 transmits prescription data 402b to host computer 400 via transmission channel 150. Host computer 400 is connected to globally accessible interchange network 450 and prescription data 402b is uploaded from host computer 400 to network 450. Prescription filling source 31 then downloads prescription data 402b from globally accessible interchange network 450 and fills the prescription.

In another form of the present invention, the physician may transmit prescription data 402b to filling source 31 by facsimile transmission over the telephone lines or the like. PDA 100 transmits prescription data 402b to host computer 400 via transmission channel 150. Host computer 400 is connected to host computer printer 403 and host computer printer 403 prints out prescription data 402b in paper format 403a. If computer printer 403 is an infrared printer, prescription data 402b may be printed out by beaming PDA 100 to computer printer 403. Infrared printers use infrared data communication, and infrared data communication involves the use of a combination transmitter and receiver in each of the communicating devices that communicate with each other. After being printed, printed prescription 403a is then sent by facsimile to filling source 31 and filled.

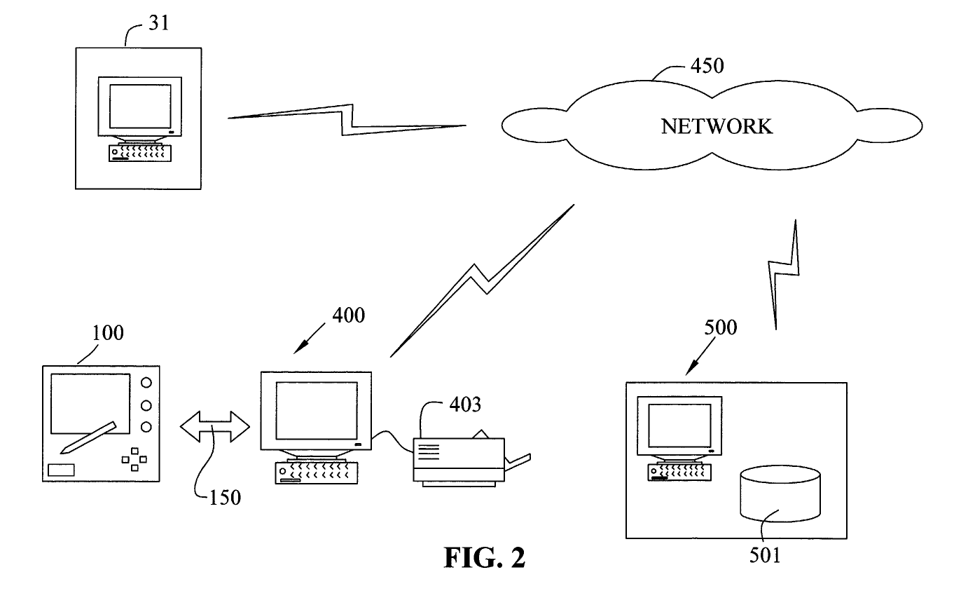

Referring to FIGS. 1 and 2, the method and system of the present invention maintains patient confidentiality in transmitting patient prescription data 402b to prescription filling source 31. The method and system of the present invention assigns a universally unique identification number to prescription data 402b each time the physician uses PDA 100 to create prescription data 402b. After PDA 100 is synchronized with host computer 400 via transmission channel 150 and prescription data 402b is stored in host computer database 402, host computer 400 prints a patient receipt on host computer printer 403. The patient receipt includes the patient's name and the unique prescription identification number that has been assigned to prescription data 402b. An electronic XML-based transaction containing the unique prescription identification and non-confidential patient information, e.g., demographic data, is sent via globally accessible interchange network 450 from host computer 400 to web-based central database 501, which is secure and housed in central office 500. When the patient presents the prescription receipt to prescription filling source 31, the person responsible for filling the prescription will access central database 501 over globally accessible interchange network 450 via a web-browser and with the use of an authorization code, enter the unique prescription identification number and complete the authentication process. In this way, confidential patient information will never be transmitted outside of host computer system 400.

A user of the method and system of the present invention may also use host computer 400 to update the FDA approved drug file stored in host computer database 402. Updated FDA file 38 may be any source of FDA-approved drug information that is accessible via globally accessible interchange network 450. Host computer 400 accesses updated FDA file 38 over globally accessible interchange network 450 and downloads the updated data to update the FDA approved drug file stored with drug data 402c in host computer database 402. For example, drug data 402c might include Drugs A, B and C in the FDA approved drug file. Updated FDA file 38 may include newly-approved Drugs D, E and F. When the user of the present invention uses host computer 400 to update the FDA approved drug file, host computer 400 accesses updated FDA file 38 over globally accessible interchange network 450 and downloads the data maintained in updated FDA file 38 to the FDA approved drug file stored in host computer database 402. Host computer database 402, recognizing that the FDA approved drug file does not include data on Drugs D, E and F, updates the file so that it then includes data on Drugs A, B, C, D, E and F.

Host computer 400 may also serve as a conduit to practice management system 200. Practice management system 200 is used by the physician in her practice to maintain patient information, patient schedule data, patient activity and prescription activity. Patient information may include, but is not limited to, the following: 1) a patient's name; 2) a patient's age; 3) a patient's sex; 4) a patient's weight; 5) a patient's height; 6) a patient's allergies; 7) a patient's medical history; and other patient information. Patient activity may include medication prescribed to a patient, tests ran on a patient and/or tests ordered to be run on a patient. Prescription activity may include the patients to whom medications were prescribed, the type of medications prescribed, the dosages of the medications prescribed, the date the medications were prescribed and the dates the prescriptions were filled. Host computer 400 retrieves patient information and patient schedule data from practice management system 200 via interface 155. Host computer 400 also uses interface 155 to store prescription activity information and patient activity information within practice management system 200.

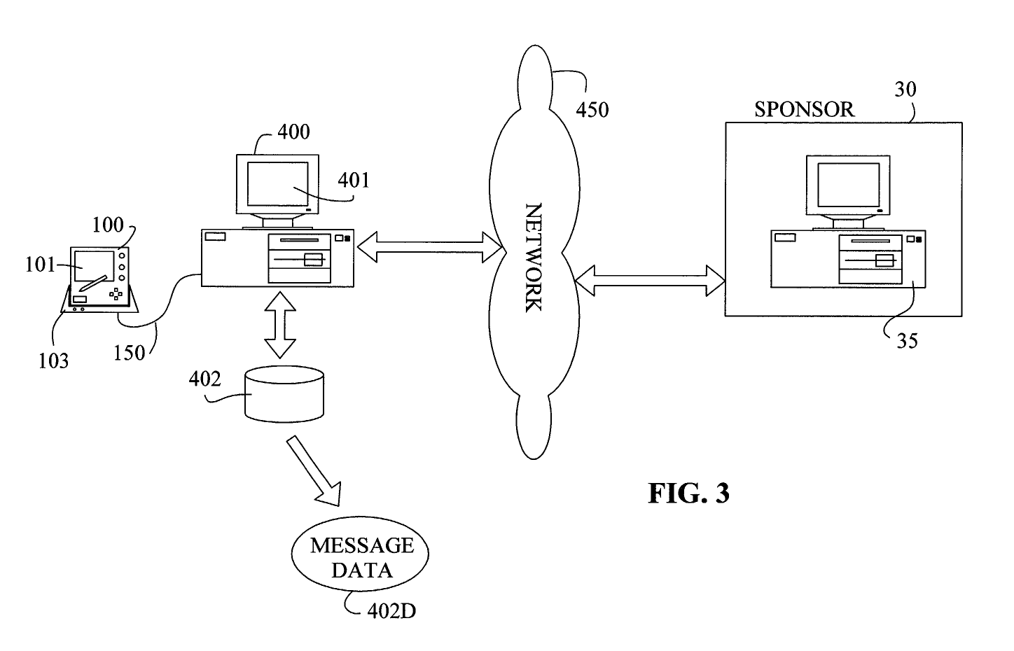

The method and system of the present invention allows physicans and sponsors to directly send and receive private electronic messages to one another by way of a private messaging conduit. Personally identifiable patient information, e.g., patient names and patient addresses, is not communicated between physicans and sponsors. Referring to FIG. 3, the private messaging conduit of the present invention is illustrated with the use of a PDA in a WAN. PDA 100 is placed into cradle 103. Cradle 103 may be any commercial docking cradle. Cradle 103 is connected to host computer 400 by transmission channel 150. Host computer 400 is connected to globally accessible interchange network 450, and cradled PDA 100 can gain access to globally accessible interchange network 450 through host computer 400. In an exemplary form of the present invention, globally accessible interchange network 450 is the Internet.

Sponsor 30 houses sponsor computer 35, which is also connected to globally accessible interchange network 450. In this way, any electronic message composed on and stored in PDA 100 may be uploaded to globally accessible interchange network 450 via host computer's 400 connection to network 450, transmitted to sponsor 30 over globally accessible interchange network 450, and then downloaded to sponsor computer 35. Likewise, any electronic message composed on sponsor computer 35 may be uploaded to globally accessible interchange network 450 and transmitted to PDA 100 over globally accessible interchange network 450 for downloading. If PDA 100 is not placed in cradle 103 when an electronic message is being transmitted by sponsor 30, host computer 400 temporarily stores the message until PDA 100 is placed into cradle 103. At that time, the electronic message is transmitted to PDA 100 during its synchronization with host computer 400. For longer storage, host computer 400 may store the electronic message as message data 402d in the host computer database 402.

For example, using PDA 100, a physican composes a message to sponsor 30, a pharmaceutical drug manufacturer. The physician may wish to inquire about the consequences of prescribing Drug A, one of drug manufacturer's 30 new drugs, to her patient who is presently using Drug B. It is important for the physican to ascertain this information because of the potential for an ADE if she prescribes Drug A without first learning of the risks involved with the use of Drug A. After composing the message, the physican saves the message in PDA data storage 102. The physician then transmits the message to host computer 400 by placing PDA 100 into cradle 103. The message may be saved as message data 402d in host computer database 402. Host computer 400 uploads the message to globally accessible interchange network 450 via host computer's 400 connection to network 450. The message is transmitted over network 450 to drug manufacturer 30 and is downloaded to sponsor computer 35. After reading the physican's message and determining the effects of the patient's concurrent use of Drug A and Drug B, drug manufacturer 30 drafts a responsive electronic message to the physician on sponsor computer 35. Sponsor computer 35 uploads the message to globally accessible interchange network 450, and the message is transmitted over network 450 and downloaded to host computer 400. The message may be saved as message data 402d in host computer database 402. The electronic message is then transmitted to PDA 100 via transmission medium 150 when PDA 100 is placed into cradle 103. In another way, the electronic message is transmitted to PDA 100 via wireless transmission channel 150.

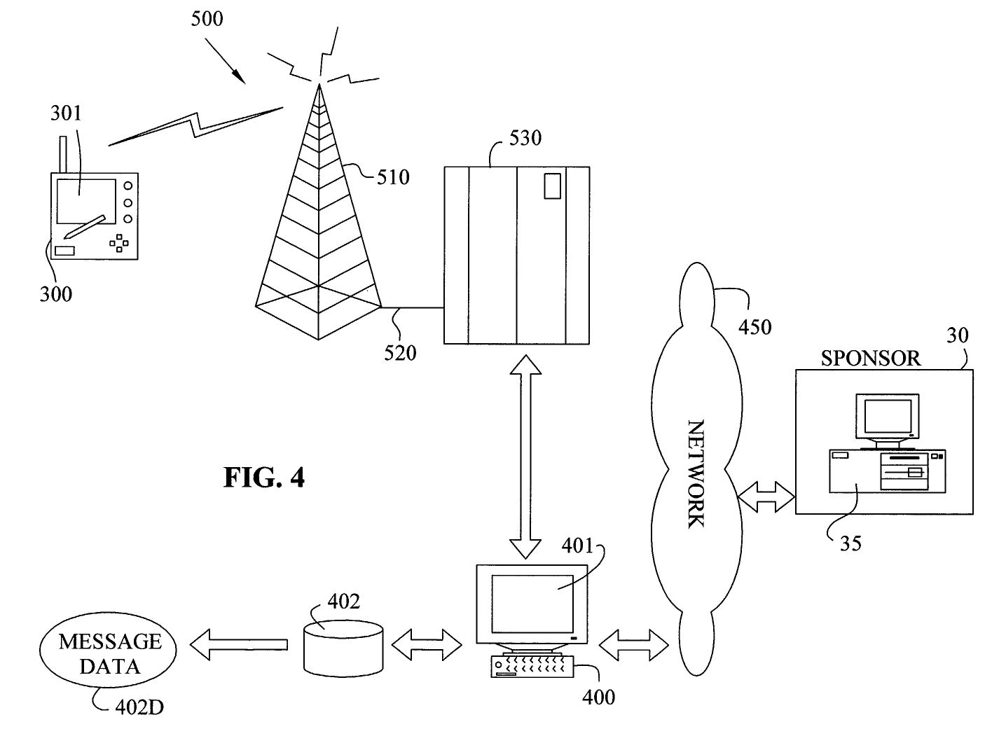

In another form of the present invention, the private messaging conduit may be implemented with the use of a wireless PDA and a WWAN. Referring to FIG. 4, wireless PDA 300 includes a wireless modem (not shown). The wireless modem communicates via radio signal with radio tower 510. Radio tower 510 is connected to mobile switching center 530 via transmission facility 520 and transmits the signal accordingly. Mobile switching center 530 passes the signal on to host computer 400, which transmits the signal to globally accessible interchange network 450. Host computer may save the electronic message as message data 402d in host computer database 400. From globally accessible interchange network 450, the signal is accessible to sponsor 30 via sponsor computer 35 connection to globally accessible interchange network 450. In this way, any electronic message composed on and stored in wireless PDA 300 may be uploaded to wireless wide area network 500 via radio waves, transmitted to sponsor 30 over WWAN 500 and globally accessible interchange network 450, and then downloaded to sponsor computer 35. Likewise, any electronic message composed on sponsor computer 35 may be uploaded to globally accessible interchange network 450, transmitted to wireless PDA 300 over globally accessible interchange network 450 and WWAN 500, and then downloaded to wireless PDA 300.

For example, sponsor 30, a pharmacy, composes a message on sponsor computer 35 to the physician whom pharmacy 30 is sponsoring. Pharmacy 30 may wish to inform the physician that pharmacy 30 is presently filling prescriptions for Drugs A, B and C—prescriptions that pharmacy 30 did not previously fill. It is important for the physican to keep current on this type of information because of the convenience to the physician's patients who must presently travel farther than pharmacy 30 to fill prescriptions for Drugs A, B and C. After composing the message on sponsor computer 35, pharmacy 30 uploads the message to globally accessible interchange network 450 via sponsor computer 35 connection to network 450. The message is transmitted over globally accessible interchange network 450 and downloaded by host computer 400. Host computer 400 may store the message as message data 402d in host computer database 402. Host computer 400 then passes the electronic message to mobile switching center 530, which transmits the message to radio tower 501 iva transmission facility 520. Physician wireless PDA 300 then receives the message in the form of a radio signal. After reading pharmacy 30 message, the physican may reply to confirm her reception of the message. The message she composes on wireless PDA 300 is uploaded to WWAN 500, downloaded by host computer 400 and transmitted over globally accessible interchange network 450. The message is then downloaded to sponsor computer 35 for pharmacy 30 to read. Again, host computer 400 may save the sent message as message data 402d in host computer database 400.

At least four (4) levels of messaging are available to pharmaceutical manufacturing sponsor 30 using the private messaging conduit of the present invention. Referring to FIG. 3 (although the same examples may be implemented with regard to the WWAN of FIG. 4), in one form of the present invention, sponsor 30 may send a general message to a physician. For example, pharmaceutical manufacturing sponsor 30 drafts an electronic message on pharmaceutical manufacturing sponsor computer 35 regarding a reappearing medical condition. The message is uploaded to globally accessible interchange network 450, transmitted over network 450 and downloaded to host computer 400. Host computer 400 may save the message as message data 402d in host computer database 402. The message is then transmitted to PDA 100 via transmission medium 150 when PDA 100 is placed in cradle 103. In another way, the message is transmitted to PDA 100 over wireless transmission channel 150. The message is presented to the physician on PDA interface 101.

In another form of the present invention, sponsor 30 may send a message to a physician regarding a particular drug class. For example, pharmaceutical manufacturing sponsor 30 drafts an electronic message on pharmaceutical manufacturing sponsor computer 35 regarding the X drug class. The message is uploaded to globally accessible interchange network 450, transmitted over network 450 and downloaded to host computer 400. Host computer 400 may save the message as message data 402d in host computer database 402. The message is then transmitted to PDA 100 via transmission medium 150 when PDA 100 is placed in cradle 103. In another way, the message is transmitted to PDA 100 over wireless transmission channel 150. The message regarding the drug class is presented to the physician on PDA interface 101.

In still another form of the present invention, sponsor 30 may send a message to a physician regarding a particular drug category. For example, pharmaceutical manufacturing sponsor 30 drafts an electronic message on pharmaceutical manufacturing sponsor computer 35 regarding the Y drug category. The message is uploaded to globally accessible interchange network 450, transmitted over network 450 and downloaded to host computer 400. Host computer 400 may save the message as message data 402d in host computer database 402. The message is then transmitted to PDA 100 via transmission medium 150 when PDA 100 is placed in cradle 103. In another way, the message is transmitted to PDA 100 over wireless transmission channel 150. The message regarding the drug category is presented to the physician on PDA interface 101.

In yet another form of the present invention, sponsor 30 may send a message to a physician regarding a particular drug. For example, pharmaceutical manufacturing sponsor 30 drafts an electronic message on pharmaceutical manufacturing sponsor computer 35 regarding the Z drug. The message is uploaded to globally accessible interchange network 450, transmitted over network 450 and downloaded to host computer 400. Host computer 400 may save the message as message data 402d in host computer database 402. The message is then transmitted to PDA 100 via transmission medium 150 when PDA 100 is placed in cradle 103. In another way, the message is transmitted to PDA 100 over wireless transmission channel 150. The message regarding the drug is presented to the physician on PDA interface 101.

In another form, the method and system of the present invention provides for a message type that allows sponsor 30 to communicate directly with a patient to encourage the patient to have his prescription filled at one of sponsor 30 local stores. For example, pharmaceutical manufacturing sponsor 30 drafts an electronic message on pharmaceutical manufacturing sponsor computer 35 encouraging a patient to have his prescription filled at one of pharmaceutical manufacturing sponsor's 30 local stores. The message is uploaded to globally accessible interchange network 450, transmitted over network 450 and downloaded to host computer 400. Host computer 400 may save the message as message data 402d in host computer database 402. The message is then transmitted to PDA 100 via transmission medium 150 when PDA 100 is placed in cradle 103. In another way, the message is transmitted to PDA 100 over wireless transmission channel 150. The message is presented to the physician on PDA interface 101.

In another form of the present invention, as shown in FIG. 2, central database 501 of central office 500 serves as a confidential data warehouse. The confidential warehouse enables the physician sponsors to collect all prescription transaction demographic data in a secure environment and, subsequently, provides the sponsors with sales and marketing intelligence. The data warehouse is available for the sponsors to analyze when, where, how and and to whom their products and services are being prescribed and recommended.

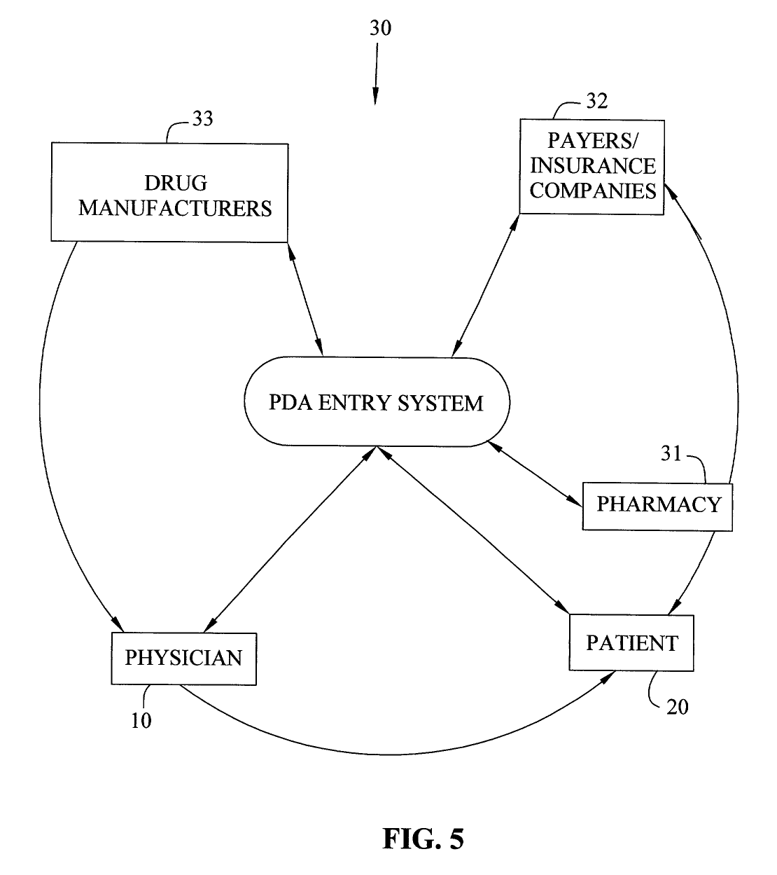

The method and system of the present invention may benefit physicians, sponsors and patients alike. In one form, the physician may benefit from the method and system of the present invention because she realizes an increased safety in the prescribing process by capturing prescriptions electronically rather than manually. For example, referring to FIG. 5, without the use of the method and system of the present invention, physician 10 must manually prescribe a patient's medication. Physician 10 may intend to write a prescription to a patient for three-hundred (300) milligrams of Drug A. However, due to physician 10 poor handwriting and pharmacy 31 misunderstanding of the manual prescription, pharmacy 31 may fill the patient's prescription for eight-hundred (800) milligrams of Drug A. This dosage, almost three-times the safe dosage, can have an adverse effect on the patient. With the use of the method and system of the present invention, physican 10 is provided with a PDA to use when capturing prescriptions. In this way, physican 10 electronic prescription data entry into her PDA can neither be poorly written by physician 10 nor misunderstood by pharmacy 31. Referring back to the example, physician 10 may enter a prescription for three hundred (300) milligrams of Drug A into her PDA. This electronic prescription may either be transmitted to the host computer, printed out and sent by facsimile to pharmacy 31, or the electronic prescription may be transmitted to the host computer and then sent to pharmacy 31 over a network connection. Either way, because physician 10 electronically entered the prescription for three hundred (300) milligrams of Drug A into her PDA, physician 10 handwriting is taken out of the equation and pharmacy 31 chances of mistaking the digital number three hundred (300) for the digital number eight hundred (800) are much smaller than if physician 10 would have written a prescription by hand for three hundred (300) milligrams of Drug A.

In another form of the present invention, a physician may benefit from the method and system of the present invention because she realizes an increased safety in the prescribing process when she is alerted to potential adverse drug effects by screening software installed on PDA 100. For example, referring to FIG. 1, a physician enters patient data 402a and prescription data 402b into PDA 100 while interviewing a patient. Unbeknownst to the physician, Patient A is allergic to Drug A. The physician, having entered Drug A into PDA 100 as part of prescription data 402b, has now prescribed a medication to which Patient A is allergic. Because PDA data storage 102 maintains Patient A's allergy data, the screening software provides a notification to the physician alerting her to this possible ADE. The alert appears to the physician on PDA interface 101. If the patient's medical record includes all the relevant medication information, this process works similarly to alert the physician in cases of either potential drug interactions or potential allergic reactions. PDA 100 may include software which identifies other similar drugs which could be prescribed as an alternative to Drug A. In this way, the software may identify Drug B as an alternative to Drug A and the physician may prescribe Drug B to Patient A in lieu of Drug A.

Referring to FIG. 5, physician 10 also may benefit from the method and system of the present invention because she realizes self-generated revenue for adding value to the prescription process. To sponsor physician 10, sponsors 30 pay a fee to a business entity implementing the method and system of the present invention. As a result of being recognized by sponsors 30 as adding value to the prescription process, physician 10 is compensated with a portion of the fee paid by sponsors 30.

Physician 10 further may benefit from the method and system of the present invention because of the reduced number of call-backs from pharmacy 31. For example, physician 10 may prescribe Drug A to Patient A. This drug, however, may be off formulary, i.e., Drug A should not be prescribed to Patient A. When pharmacy 31 receives the physician's electronic prescription for Drug A, pharmacy 31 calls physician 10 to inform her that her prescription is off formulary. Physician 10 then goes back and re-writes a prescription for a drug, Drug B, that is on formulary. With the use of the method and system of the present invention, however, physician 10 uses her PDA to verify whether Drug A is on/off formulary before entering the prescription. In this way, physican 10 is neither called away from her patients nor distracted from fulfilling her duties by constantly answering callbacks from pharmacy 31 indicating that physician 10 prescriptions were off formulary.

Sponsors 30 also may benefit from the method and system of the present invention. Sponsors 30 include pharmacy 31, insurance companies 32, drug manufacturers 33 and other entities that pay a fee to sponsor physician 10. Sponsors 30 products and services may receive preferential presence in front of physician 10 as physician 10 uses her PDA.

Referring to FIGS. 1 and 5, in one form of the present invention, pharmacy 31 may benefit as a sponsor from the preferentional presence provided by the method and system of the present invention because pharmacy 31 logo is displayed on PDA interface 101 of physician 10 PDA 100 when the physician launches the system of the present invention. In this way, physician 10 uses her PDA 100 to capture electronic prescriptions which may potentially increase pharmacy 31 retail traffic. For example, retail pharmacy 31 such as Pharmacy X may have its PHARMACY X logo appear on PDA interface 101. Being constantly reminded of Pharmacy X's services via PDA 100, the physician is more likely to create prescriptions that may be filled at Pharmacy X than the physician is likely to create without the constant reminder. Consequently, pharmacy 31 may realize an increase in retail traffic.

In another form, pharmacy 31 may benefit from the preferential presence provided by the method and system of the present invention because pharmacy 31 advertisements are printed on printed prescriptions 403a. For example, retail pharmacy 31 may have an advertisement reading “Pharmacy X is the best” printed on printed prescription 403a. Patients obtaining printed prescriptions 403a which display pharmacy 31 advertisements are more likely to have their prescriptions filled at pharmacy 31 than those patients who obtain printed prescriptions 403a that do not display pharmacy 31 advertisements.

In still another form of the present invention, pharmacy 31 may realize a benefit when its local store(s) appear at the top of the list of all local pharmacies on physician 10 PDA interface 101. For example, when physician 10 reaches the point in her electronic prescription process to elect a filling agent to fill her prescription of Drug A, a list is displayed on physician 10 PDA interface 101 which includes a number of pharmacies which may fill physician 10 prescription of Drug A. Pharmacy 31 preferential presence on PDA interface 101 provides for pharmacy 31 local store(s) to be listed at the top of the list. The prominent display of pharmacy 31 local store(s) increases the likelihood of either physician 10 electing one of pharmacy 31 stores to fill her patient's prescription or physician 10 recommending to her patient to get the prescription filled at pharmacy 31 store.

Pharmacy 31 also may benefit from the method and system of the present invention because, as described above, the present invention reduces the number of call-backs pharmacy 31 must make to physician 10 informing her that her prescription was off formulary or that there is an undesirable drug interaction.

Pharmacy 31 further may benefit from the method and system of the present invention because the present invention may authenticate the prescription being filled. For example, referring to FIGS. 1 and 2, a physician enters prescription data 402b regarding Patient A in PDA 100. Prescription data 402b includes a prescription for Drug A. The method and system of the present invention assigns a universally unique identification number to prescription data 402b. The physician saves prescription data 402b in PDA data storage 102 so that the prescription may be transmitted to a filling agent such as pharmacy 31. Prescription data 402b is then transmitted to host computer 400 by way of transmission channel 150. After PDA 100 is synchronized with host computer 400 via transmission channel 150, host computer 400 prints a patient receipt on host computer printer 403. The patient receipt includes the patient's name and the unique prescription identification number that has been assigned to prescription data 402b. An electronic XML-based transaction containing the unique prescription identification and non-confidential patient information, e.g., demographic data, is sent via globally accessible interchange network 450 from host computer 400 to web-based central database 501, which is secure and housed in central office 500. The patient then presents the prescription receipt to prescription filling source 31 to fill the prescription. Before pharmacy 31 fills the prescription to Patient A for Drug A, pharmacy 31 may wish to authenticate that Drug A was actually prescribed by the physician to Patient A. The person responsible for filling the prescription will access central database 501 over globally accessible interchange network 450 via a web-browser and the use of an authorization code, enter the unique prescription identification number and complete the authentication process. In this way, if Patient A was not prescribed Drug A, pharmacy 31 knows in advance of filling an erroneous prescription.

Referring to FIGS. 1 and 5, insurance company 32 may benefit as a sponsor from the method and system of the present invention because accurate prescriptions greatly reduce insurance company 32 potential for incurring liability for medical malpractice claims. For example, insurance company 32 may insure physician 10 against medical malpractice. Each time that physician 10 creates a poorly written manual prescription, physician 10 creates a potential risk that the prescription may be filled incorrectly and cause her patient to suffer an ADE. This phenomena then enhances the risk that insurance company 32 may incur liability. However, because of the electronic nature of the method and system of the present invention, the chances of physician 10 prescription being improperly filled due to poor handwriting is decreased. The level of efficiency and accuracy provided by the method and system of the present invention reduces the risk of patients being injured. Indeed, any ADE that is prevented using the method and system of the present invention reduces the chances of insurance company 32 incurring liability for medical malpractice claims.

Insurance company 32 also may benefit from the method and system of the present invention because the present invention assures insurance company 32 that physicians 10 are prescribing medications that are formulary compliant to insurance company 32 guidelines. For example, insurance company 32 may insure a patient's use of Drug A but may not insure a patient's use of Drug B. Because the method and system of the present invention allows physician 10 to use her PDA 100 to verify that her prescriptions are on formulary, insurance company 32 is assured that only those medications which it insures is being prescribed by physician 10 whom it sponsors.

Drug manufacturer 33 may benefit as a sponsor from the method and system of the present invention because drug manufacturer 33 products and services may receive preferential presence in front of physician 10, without distracting physician 10 as she prescribes a drug. In one form of the present invention, this preferential presence occurs in the form of a logo displayed on physician 10 PDA interface 101 when the system of the present invention is launched. For example, drug manufacturer 33 may have its Pharmaceutical X logo displayed on physician's 10 PDA interface 101 every time physician 10 launches the system of the present invention while using PDA 100.

In another form, this preferential presence occurs in the form of printed advertisements displayed on patient prescription receipts. For example, drug manufacturer 33 may have an ad reading “Pharmaceutical X is the best” displayed on a patient's printed prescription receipt. In this way, when the patient has his prescription filled, the prescription filling source becomes more aware of drug manufacturer 33. This awareness increases the likelihood that the prescription filling source may fill the patient's prescription with drug manufacturer 33 product(s).

In still another form of the present invention, this preferential presence occurs in the form of advantageous product positioning within the drug list displayed on PDA interface 101. For example, drug manufacturer 33 realizes a benefit when manufacturer 33 drugs appear at the top of all drugs in each drug class on physician 10 PDA interface 101 when physician 10 elects to select a drug by its class. By drug manufacturer 33 drugs being displayed at the top of the drug class list, physician 10 likelihood of selecting drug manufacturer 33 drugs is higher than if drug manufacturer 33 drugs were displayed at the bottom of the drug class list on physician 10 PDA interface 101.

Drug manufacturer 33 further may benefit from the method and system of the present invention because it allows drug manufacturer 33 to send electronic messages directly to PDA 100 of the physician whom drug manufacturer 33 is sponsoring by way of the private messaging conduit. For example, referring to FIG. 3, Drug X is a new drug that has just been approved by the FDA. Drug manufacturer 30 drafts an electronic message on drug manufacturer computer 35 to its sponsoree physician regarding the potential uses of Drug X. The message is uploaded by drug manufacturer computer 35 to globally accessible interchange network 450, transmitted over network 450, downloaded to host computer 400 and then transmitted directly to physician's PDA 100 over transmission channel 150. In this way, the physician is acutely aware of when she is able to prescribe Drug X to her patients and could inform her patients accordingly. Host computer 400 may save the message as message data 402d in host computer database 402.

Referring to FIG. 5, patient 20 also may benefit from the method and system of the present invention. Because the system of the present invention alerts physician 10 when she prescribes a medication that could potentially cause patient 20 to suffer from an adverse drug event, it reduces the likelihood that patient 20 will suffer from an ADE. Patient 20 further may benefit from the method and system of the present invention because it provides for storing information regarding patient 20 allergies and active medications. In this way, if patient 20 returns to physician 10 several months after receiving a prescription, the method and system of the present invention provides for accessing patient 20 allergy data and alerting physician 10 if she prescribes a medication to which patient 20 is allergic or which has a potential negative interaction with the patient's active medications.

For example, referring to FIG. 1, PDA data storage 102 stores a patient's active prescription data with prescription data 402b and a patient's allergy data with drug data 402c. Unbeknownst to the physician, Patient A is allergic to Drug A. Using PDA 100, the physician prescribes Drug A to Patient A by entering prescription data 402b into PDA 100. Because PDA data storage 102 maintains both Patient A's active prescription data and allergy data, the method and system of the present invention provides a notification to the physician alerting her of this potential harmful prescription. Before the physician transmits Patient A's prescription data 402b to filling source 31, the physician may be alerted on PDA interface that Patient A is allergic to Drug A or that Drug A may negatively interact with Patient A's active medications. PDA 100 may include software which identifies other drugs which could be prescribed as an alternative to Drug A. Accordingly, the software may identify Drug B as being similar to Drug A, and the physician may prescribe Drug B to Patient A instead of Drug A.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A method for electronically processing prescriptions via a personal digital assistant (PDA), comprising the steps of:
(a) providing a physician with a PDA for generating prescription data;
(b) transmitting said prescription data over a network to a prescription filling source; and
(c) providing a sponsor to pay for the physician's use of said PDA, said sponsor having the ability to direct sponsor messages to the physician on said PDA.

2. The method of claim 1 wherein said PDA includes a user interface.

3. The method of claim 1 wherein said PDA includes a data storage.

4. The method of claim 3 wherein said data storage stores patient data.

5. The method of claim 3 wherein said data storage stores prescription data.

6. The method of claim 3 wherein said data storage stores drug data.

7. The method of claim 3 wherein said data storage stores message data.

8. The method of claim 1 wherein said sponsor message includes a sponsor's logo displayed on the user interface of said PDA.

9. The method of claim 1 wherein said sponsor message includes a sponsor's advantageous product positioning on the user interface of said PDA.

10. The method of claim 1 further comprising the step of transmitting an electronic message over said network between said sponsor and the physician.

11. The method of claim 10 wherein said electronic message includes data regarding a drug class.

12. The method of claim 10 wherein said electronic message includes data regarding a drug category.

13. The method of claim 10 wherein said electronic message includes data regarding a drug.

14. The method of claim 1 further comprising the step of providing the physician with an adverse drug event notification via said PDA.

15. The method of claim 14 wherein said adverse drug event notification includes patient data.

16. The method of claim 14 wherein said adverse drug event notification includes patient prescription data.

17. The method of claim 14 wherein said adverse drug event notification includes drug data.

18. The method of claim 1 further comprising the step of providing a host computer for enabling said PDA to communicate with said network.

19. The method of claim 18 wherein said host computer includes a database.

20. The method of claim 19 wherein said database stores patient data.

21. The method of claim 19 wherein said database stores prescription data.

22. The method of claim 19 wherein said database stores drug data.

23. The method of claim 19 wherein said database stores message data.

24. The method of claim 1 wherein the transmitting step involves maintaining confidentiality of the prescription data.

25. The method of claim 24 wherein the maintaining step further includes the steps of:
(a) assigning a unique identification number to the prescription data;
(b) transmitting the unique identification number over a network to a central database;
(d) enabling the prescription filling source to access the central database; and
(e) authenticating the prescription data by using the unique identification number.

26. The method of claim 1 wherein said network is a globally accessible information interchange network.

27. A computer system for electronically processing prescriptions via a personal digital assistant (PDA), comprising:
(a) means for enabling a physician to generate prescription data via a PDA;
(b) means for transmitting said prescription data over a network to a prescription filling source; and
(c) means for enabling a sponsor to direct sponsor messages to the physician on said PDA.

28. The computer system of claim 27 wherein said PDA includes a user interface.

29. The computer system of claim 27 wherein said PDA includes a data storage.

30. The computer system of claim 29 wherein said data storage stores patient data.

31. The computer system of claim 29 wherein said data storage stores prescription data.

32. The computer system of claim 29 wherein said data storage stores drug data.

33. The computer system of claim 29 wherein said data storage stores message data.

34. The computer system of claim 27 wherein said sponsor message includes a sponsor's logo displayed on the user interface of said PDA.

35. The computer system of claim 27 wherein said sponsor message includes a sponsor's advantageous product positioning on the user interface of said PDA.

36. The computer system of claim 27 further comprising means for transmitting an electronic message over said network between said sponsor and the physician.

37. The computer system of claim 36 wherein said electronic message includes data regarding a drug class.

38. The computer system of claim 36 wherein said electronic message includes data regarding a drug category.

39. The computer system of claim 36 wherein said electronic message includes data regarding a drug.

40. The computer system of claim 27 further comprising means for providing the physician with an adverse drug event notification via said PDA.

41. The computer system of claim 40 wherein said adverse drug event notification includes patient data.

42. The computer system of claim 40 wherein said adverse drug event notification includes patient prescription data.

43. The computer system of claim 40 wherein said adverse drug event notification includes drug data.

44. The computer system of claim 27 further comprising means for providing a host computer for enabling said PDA to communicate with said network.

45. The computer system of claim 44 wherein said host computer includes a database.

46. The computer system of claim 45 wherein said database stores patient data.

47. The computer system of claim 45 wherein said database stores prescription data.

48. The computer system of claim 45 wherein said database stores drug data.

49. The computer system of claim 45 wherein said database stores message data.

50. The computer system of claim 27 wherein the transmitting means involves means for maintaining confidentiality of the prescription data.

51. The computer system of claim 50 wherein the maintaining means further include:
(a) means for assigning a unique identification number to the prescription data;
(b) means for transmitting the unique identification number over a network to a central database;
(d) means for enabling the prescription filling source to access the central database; and
(e) means for authenticating the prescription data by using the unique identification number.

52. The computer system of claim 27 wherein said network is a globally accessible information interchange network.

53. A machine-readable program storage device for storing encoded instructions for a method of electronically processing prescriptions via a personal digital assistant (PDA), the method comprising the steps of:
(a) providing a physician with a PDA for generating prescription data;
(b) transmitting said prescription data over a network to a prescription filling source; and
(c) providing a sponsor to pay for the physician's use of said PDA, said sponsor having the ability to direct sponsor messages to the physician on said PDA.

54. The machine-readable program storage device of claim 53 wherein said PDA includes a user interface.

55. The machine-readable program storage device of claim 53 wherein said PDA includes a data storage.

56. The machine-readable program storage device of claim 55 wherein said data storage stores patient data.

57. The machine-readable program storage device of claim 55 wherein said data storage stores prescription data.

58. The machine-readable program storage device of claim 55 wherein said data storage stores drug data.

59. The machine-readable program storage device of claim 55 wherein said data storage stores message data.

60. The machine-readable program storage device of claim 53 wherein said sponsor message includes a sponsor's logo displayed on the user interface of said PDA.

61. The machine-readable program storage device of claim 53 wherein said sponsor message includes a sponsor's advantageous product positioning on the user interface of said PDA.

62. The machine-readable program storage device of claim 53, wherein the method further comprises the step of transmitting an electronic message over said network between said sponsor and the physician.

63. The machine-readable program storage device of claim 62 wherein said electronic message includes data regarding a drug class.

64. The machine-readable program storage device of claim 62 wherein said electronic message includes data regarding a drug category.

65. The machine-readable program storage device of claim 62 wherein said electronic message includes data regarding a drug.

66. The machine-readable program storage device of claim 53, wherein the method further comprises the step of providing the physician with an adverse drug event notification via said PDA.

67. The machine-readable program storage device of claim 66 wherein said adverse drug event notification includes patient data.

68. The machine-readable program storage device of claim 66 wherein said adverse drug event notification includes patient prescription data.

69. The machine-readable program storage device of claim 66 wherein said adverse drug event notification includes drug data.

70. The machine-readable program storage device of claim 53, wherein the method further comprises the step of providing a host computer for enabling said PDA to communicate with said network.

71. The machine-readable program storage device of claim 70 wherein said host computer includes a database.

72. The machine-readable program storage device of claim 71 wherein said database stores patient data.

73. The machine-readable program storage device of claim 71 wherein said database stores prescription data.

74. The machine-readable program storage device of claim 71 wherein said database stores drug data.

75. The machine-readable program storage device of claim 71 wherein said database stores message data.

76. The machine-readable program storage device of claim 53, wherein the transmitting step of the method involves maintaining confidentiality of the prescription data.

77. The machine-readable program storage device of claim 76, wherein the maintaining step of the method further includes the steps of:
(a) assigning a unique identification number to the prescription data;
(b) transmitting the unique identification number over a network to a central database;
(d) enabling the prescription filling source to access the central database; and
(e) authenticating the prescription data by using the unique identification number.

78. The machine-readable program storage device of claim 53 wherein said network is a globally accessible information interchange network.
